(19) United States
(12) Patent Application Publication
(10) Pub. No.: US 2014/0049701 A1
(43) Pub. Date: Feb. 20, 2014

(54) TOUCH PANEL AND METHOD OF FORMING A TOUCH PANEL

(71) Applicant: YOMORE TECHNOLOGY CO., LTD., Kaohsiung City (TW)

(72) Inventors: Jao-Ching Lin, KAOHSIUNG CITY (TW); Wen-Ting Lee, KAOHSIUNG CITY (TW); Chun-Kai Ni, KAOHSIUNG CITY (TW)

(73) Assignee: YOMORE TECHNOLOGY CO., LTD., Kaohsiung City (TW)

(21) Appl. No.: 13/968,434

(22) Filed: Aug. 16, 2013

(30) Foreign Application Priority Data
Aug. 16, 2012 (TW) 101129700

(51) Int. Cl. G06F 1/16

(52) U.S. Cl. CPC G06F 1/169
USPC 349/12; 29/850

(57) ABSTRACT

A touch panel includes a film and a cover lens. Sensing units of a sensing circuit, first wires coupled to the sensing circuit, and second wires coupled between the first wires and a processor are formed on the film. The film is attached to the cover lens by an adhesive method.

### BACKGROUND OF THE INVENTION

1. Field of the Invention

The present invention relates to a touch panel and a method of forming a touch panel, and particularly to a touch panel and a method of forming a touch panel that can form sensing circuit, and wires coupled to the sensing circuit and a processor of the touch panel on a film.

2. Description of the Prior Art

Please refer to FIG. 1. FIG. 1 is a diagram illustrating a touch panel 100 according to the prior art. As shown in FIG. 1, the prior art usually utilizes a sputtering deposition method or a printing method to lay silver paste on a cover lens (e.g. a glass transparent cover) 102 to forma sensing circuit (including a plurality of sensing units) 104 and wires 106 coupled to the sensing circuit 104. Then, the prior art utilizes a lamination process to laminate a flexible printed circuit board 112 which a processor 108 and wires 110 coupled to the processor 108 are installed on to the cover lens 102 to make the wires 110 be connected to the wires 106.

However, the prior art has disadvantages as follows: first, the cover lens 102 and the flexible printed circuit board 112 need to be processed, respectively, and lamination between the cover lens 102 and the flexible printed circuit board 112 may consume too much manpower and cost; second, the lamination between the cover lens 102 and the flexible printed circuit board 112 needs very accurate alignment to ensure that connection between the wires 106 and the wires 110 is good, but the wires 106 and the wires 110 can not be easily aligned to connect each other because width of the wires 106 and the wires 110 is very small; third, during the lamination between the cover lens 102 and the flexible printed circuit board 112, pressure of the lamination may break the wires 106 and the wires 110; fourth, a process of the touch panel 100 becomes more complicated to connect conductive glass and the silver paste formed on the cover lens 102 to copper of the flexible printed circuit board 112; and fifth, during the prior art utilizing the sputtering deposition method to lay the silver paste on the cover lens 102 to form the wires 106, if a surface of the cover lens 102 exists ink, the silver paste does not be sputtered on the cover lens 102 easily.

Therefore, the prior art is not a good production method for forming the touch panel 100.

### SUMMARY OF THE INVENTION

An embodiment provides a touch panel . The touch panel includes a film and a cover lens. Sensing units of a sensing circuit, first wires coupled to the sensing circuit, and second wires coupled between the first wires and a processor are formed on the film. The film is attached to the cover lens by an adhesive method.

Another embodiment provides a method of forming a touch panel. The method includes installing a processor on a film; forming sensing units of a sensing circuit, first wires coupled to the sensing circuit, and second wires coupled between the first wires and the processor on the film; and attaching the film to a cover lens.

The present invention provides a touch panel and a method of forming a touch panel. The touch panel and the method form sensing units of a sensing circuit, first wires coupled to the sensing circuit, and second wires coupled between the first wires and a processor on a film, and then attach the film which the sensing units of the sensing circuit, the first wires coupled to the sensing circuit, and the second wires coupled between the first wires and the processor are formed on to a cover lens by an adhesive method. Therefore, the present invention has advantages as follows: first, after the sensing units of the sensing circuit, the first wires coupled to the sensing circuit, and the second wires coupled between the first wires and the processor are formed on the film, the present invention can make a process of the touch panel quick and convenient because the present invention directly attaches the film to the cover lens to complete the process of the touch panel; second, because the present invention does not need a flexible printed circuit board, poor bonding between the first wires and the second wires does not occur in the present invention; third, because the present invention directly forms the sensing units of the sensing circuit, the first wires coupled to the sensing circuit, and the second wires coupled between the first wires and the processor on two sides of the film or the cover lens, the present invention does not need accurate alignment; fourth, because the present invention does not need a lamination process of a flexible printed circuit board, disconnection between the first wires and the second wires does not occur; and fifth, because the processor can be directly installed on the film by a low temperature process technology, and can be directly coupled to the sensing units of the sensing circuit by the first wires and the second wires, the present invention can make the process of the touch panel simpler.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a touch panel according to the prior art.

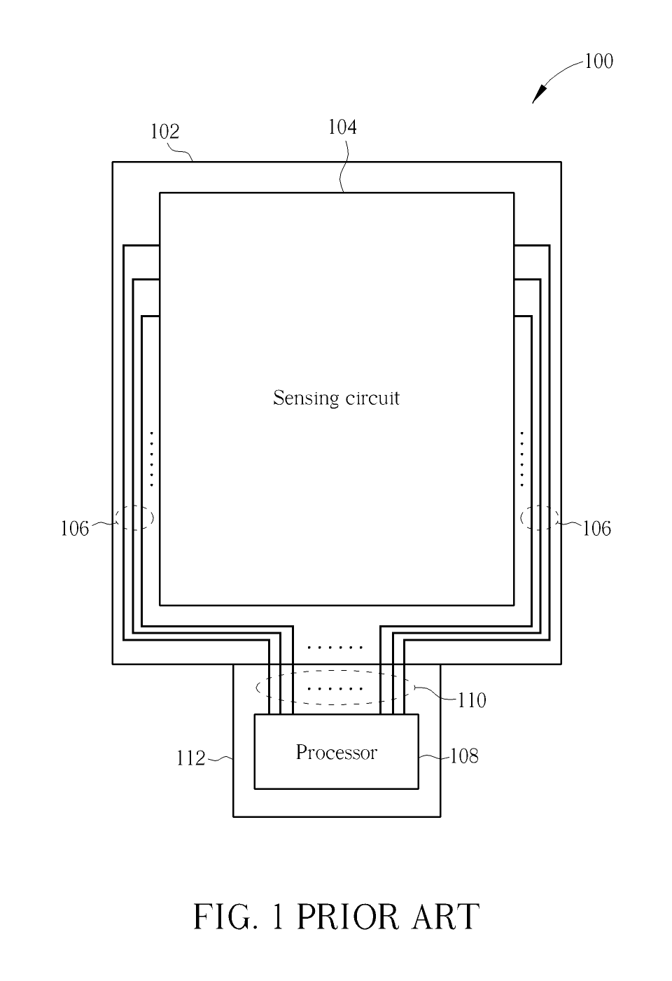

FIG. 2 is a diagram illustrating the film.

FIG. 3 is a diagram illustrating a cross-section of the touch panel.

FIG. 4 is diagram illustrating a cross-section of a touch panel according to another embodiment.

FIG. 5 is diagram illustrating a cross-section of a touch panel according to another embodiment.

FIG. 6 is a flowchart illustrating a method of forming a touch panel according to another embodiment.

### DETAILED DESCRIPTION

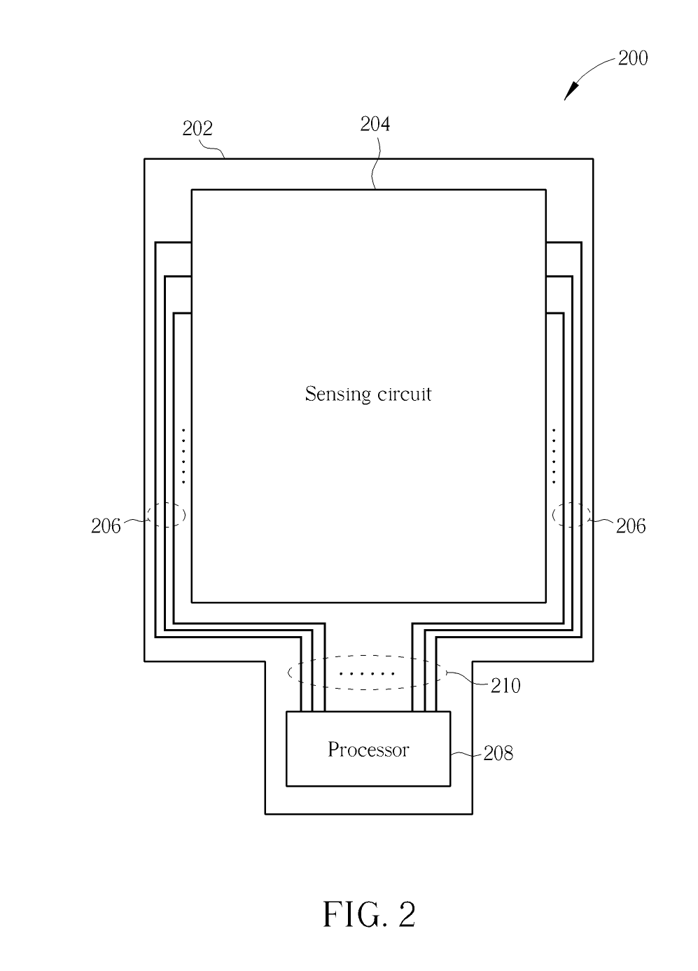

An embodiment provides a touch panel 200, where the touch panel 200 includes a film 202 and a cover lens 212, and the film 202 cam be a polyethylene terephthalate film or a polyethylene naphthalate film. But, the present invention is not limited to the film 202 being a polyethylene terephthalate film or a polyethylene naphthalate film. That is to say, the film 202 can be another optical transparent film. Please refer to FIG. 2. FIG. 2 is a diagram illustrating the film 202. As shown in FIG. 2, sensing units of a sensing circuit 204, first wires 206 coupled to the sensing circuit 204, and second wires 210 coupled between the first wires 206 and a processor 208 are formed on the film 202. The sensing units of the sensing circuit 204, the first wires 206, and the second wires 210 can be formed on the film 202 by a printing method, an evaporation method, a sputtering deposition method, a chemical vapor deposition method, a photolithography method, or an etching method. But, the present invention is not limited to the sensing units of the sensing circuit 204, the first wires 206, and the second wires 210 being formed on the film 202 by the printing method, the evaporation method, the sputtering deposition method, the chemical vapor deposition method, the photolithography method, or the etching method. That is to say, the sensing units of the sensing circuit 204, the first wires 206, and the second wires 210 can further be formed on the film 202 by another method. In addition, the sensing units of the sensing circuit 204, the first wires 206, and the second wires 210 can be silver paste or conductive glass (e.g. Indium Tin Oxide (ITO), Fluorine-doped Tin Oxide (FTO), and so on).

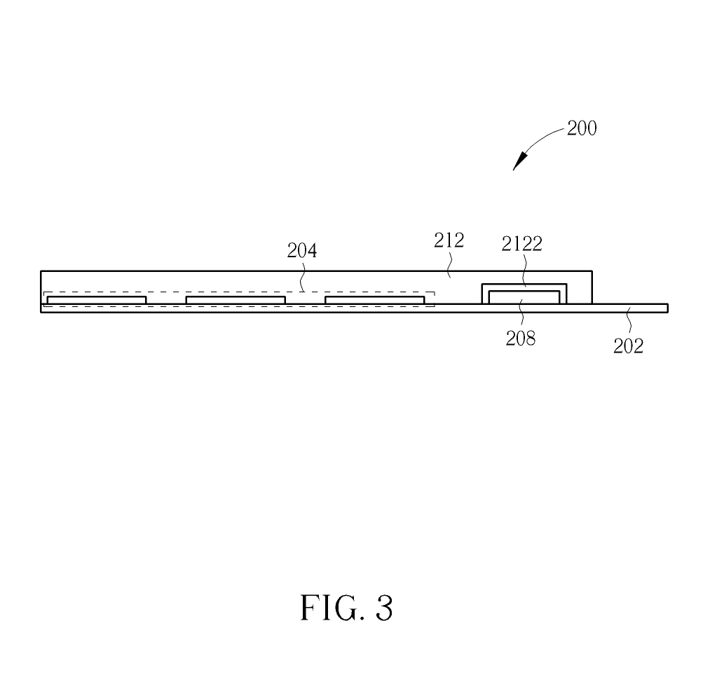

Please refer to FIG. 3. FIG. 3 is a diagram illustrating a cross-section of the touch panel 200. As shown in FIG. 3, the film 202 is attached to the cover lens 212 by an adhesive method, where the cover lens 212 includes a hole 2122. The hole 2122 is used for covering the processor 208, and the processor 208 is installed on the film 202. Therefore, a location of the film 202 on which the processor 208 is installed needs to coincide with a location of the hole 2122. In addition, it is noted that the sensing circuit 204 shown in FIG. 3 is one dimensional.

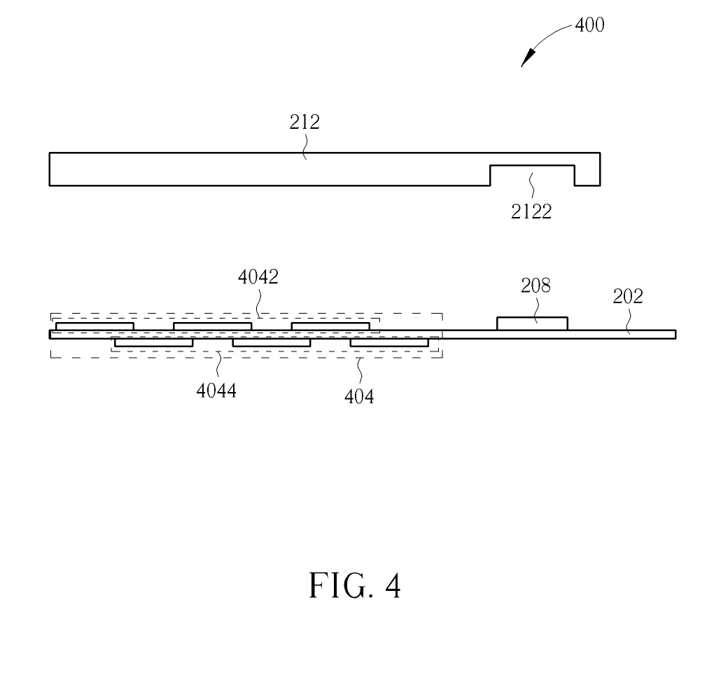

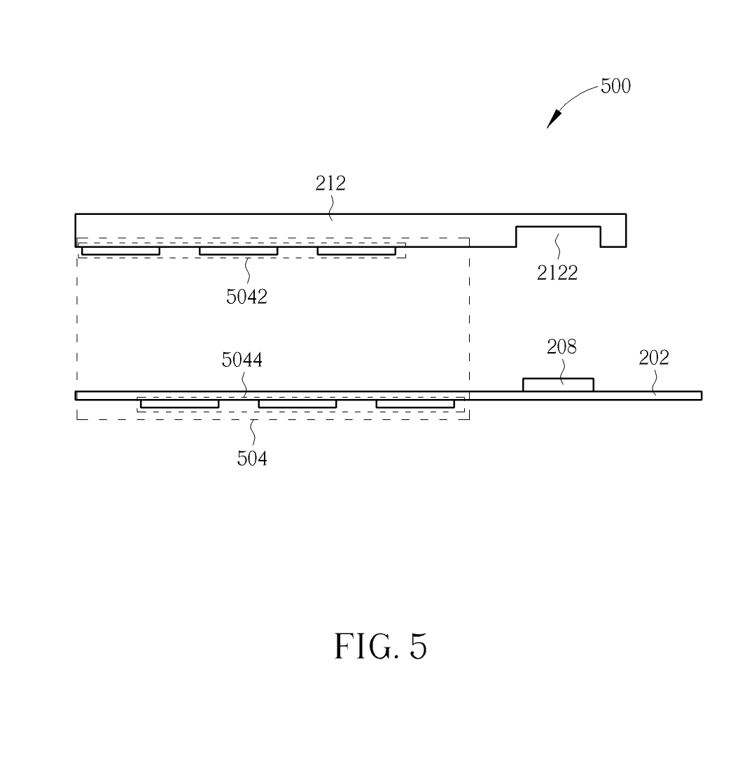

Please refer to FIG. 4 and FIG. 5. FIG. 4 and FIG. 5 are diagrams illustrating cross-sections of a touch panel 400 and a touch panel 500 according to other embodiments. As shown in FIG. 4, a difference between the touch panel 400 and the touch panel 200 is that a sensing circuit 404 of the touch panel 400 is a two dimensional sensing circuit, where first dimensional sensing units 4042 and second dimensional sensing units 4044 of the sensing circuit 404 are formed on two opposite sides of the film 202, respectively, and the first dimensional sensing units 4042 of the sensing circuit 404 are perpendicular to the second dimensional sensing units 4044 of the sensing circuit 404. In addition, subsequent operational principles of the touch panel 400 are the same as those of the touch panel 200, so further description thereof is omitted for simplicity.

As shown in FIG. 5, a difference between the touch panel 500 and the touch panel 200 is that a sensing circuit 504 of the touch panel 500 is a two dimensional sensing circuit, where first dimensional sensing units 5042 of the sensing circuit 504 are formed on one side of the cover lens 212 and second dimensional sensing units 5044 of the sensing circuit 504 are formed on one side of the film 202, where the first dimensional sensing units 5042 of the sensing circuit 504 are perpendicular to the second dimensional sensing units 5044 of the sensing circuit 504. Further, in another embodiment of the present invention, the first dimensional sensing units 5042 of the sensing circuit 504 are formed on one side of the film 202 and the second dimensional sensing units 5044 of the sensing circuit 504 are formed on one side of the cover lens 212. In addition, subsequent operational principles of the touch panel 500 are the same as those of the touch panel 200, so further description thereof is omitted for simplicity.

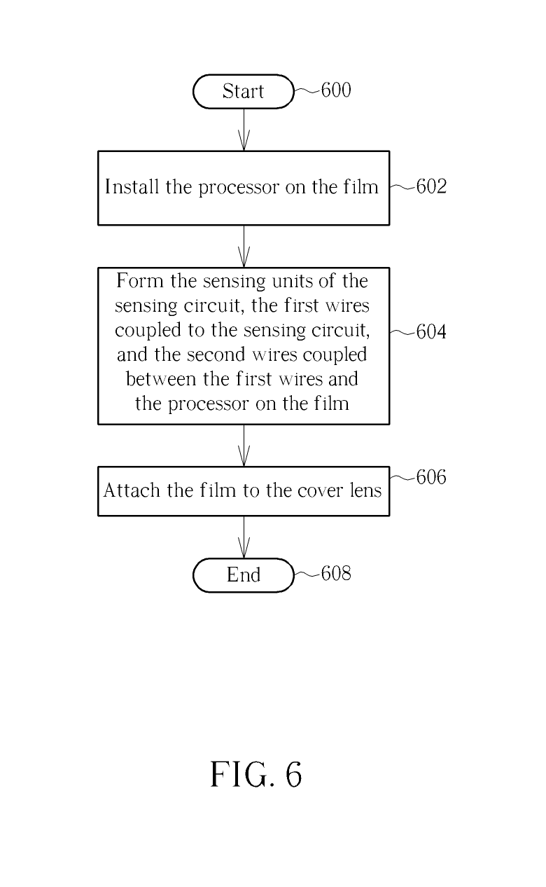

Please refer to FIG. 2, FIG. 3, FIG. 4, FIG. 5, and FIG. 6. FIG. 6 is a flowchart illustrating a method of forming a touch panel according to another embodiment. The method in FIG. 6 is illustrated using the film 202 in FIG. 2, the touch panel 300 in FIG. 3, the touch panel 400 in FIG. 4, and the touch panel 500 in FIG. 5. Detailed steps are as follows:

Step 600: Start.

Step 602: Install the processor 208 on the film 202.

Step 604: Form the sensing units of the sensing circuit, the first wires 206 coupled to the sensing circuit, and the second wires 210 coupled between the first wires 206 and the processor 208 on the film 202.

Step 606: Attach the film 202 to the cover lens 212.

Step 608: End.

Take FIG. 2 and FIG. 3 as an example. In Step 604 and Step 606, the sensing units of the sensing circuit 204, the first wires 206, and the second wires 210 can be formed on the film 202 by a printing method, an evaporation method, a sputtering deposition method, a chemical vapor deposition method, a photolithography method, or an etching method, where the sensing units of the sensing circuit 204, the first wires 206, and the second wires 210 can be silver paste or conductive glass. As shown in FIG. 3, the film 202 is attached to the cover lens 212 by an adhesive method, where the cover lens 212 includes the hole 2122. The hole 2122 is used for covering the processor 208. Therefore, the location of the film 202 on which the processor 208 is installed needs to coincide with the location of the hole 2122. In addition, it is noted that the sensing circuit 204 shown in FIG. 3 is one dimensional.

Take FIG. 2 and FIG. 4 as an example. In Step 604 and Step 606, the sensing units of the sensing circuit 404 can also be formed on the film 202 by the printing method, the evaporation method, the sputtering deposition method, the chemical vapor deposition method, the photolithography method, or the etching method, where the sensing units of the sensing circuit 404 can also be silver paste or conductive glass. As shown in FIG. 4, the sensing circuit 404 is a two dimensional sensing circuit, where the first dimensional sensing units 4042 and the second dimensional sensing units 4044 of the sensing circuit 404 are formed on two opposite sides of the film 202, respectively, and the first dimensional sensing units 4042 of the sensing circuit 404 are perpendicular to the second dimensional sensing units 4044 of the sensing circuit 404

Take FIG. 2 and FIG. 5. In Step 604 and Step 606, the sensing units of the sensing circuit 504 can also be formed on the film 202 by the printing method, the evaporation method, the sputtering deposition method, the chemical vapor deposition method, the photolithography method, or the etching method, where the sensing units of the sensing circuit 504 can also be silver paste or conductive glass. As shown in FIG. 5, the sensing circuit 504 is also a two dimensional sensing circuit, where the first dimensional sensing units 5042 of the sensing circuit 504 are formed on one side of the cover lens 212 and the second dimensional sensing units 5044 of the sensing circuit 504 are formed on one side of the film 202, where the first dimensional sensing units 5042 of the sensing circuit 504 are perpendicular to the second dimensional sensing units 5044 of the sensing circuit 504. Further, in another embodiment of the present invention, the first dimensional sensing units 5042 of the sensing circuit 504 are formed on one side of the film 202 and the second dimensional sensing units 5044 of the sensing circuit 504 are formed on one side of the cover lens 212.

To sum up, the touch panel and the method of forming the touch panel form the sensing units of the sensing circuit, the first wires coupled to the sensing circuit, and the second wires coupled between the first wires and the processor on the film, and then attach the film which the sensing units of the sensing circuit, the first wires coupled to the sensing circuit, and the second wires coupled between the first wires and the processor are formed on to the cover lens by an adhesive method. Therefore, the present invention has advantages as follows: first, after the sensing units of the sensing circuit, the first wires coupled to the sensing circuit, and the second wires coupled between the first wires and the processor are formed on the film, the present invention can make a process of the touch panel quick and convenient because the present invention directly attaches the film to the cover lens to complete the process of the touch panel; second, because the present invention does not need a flexible printed circuit board, poor bonding between the first wires and the second wires does not occur in the present invention; third, because the present invention directly forms the sensing units of the sensing circuit, the first wires coupled to the sensing circuit, and the second wires coupled between the first wires and the processor on two sides of the film or the cover lens, the present invention does not need accurate alignment; fourth, because the present invention does not need a lamination process of a flexible printed circuit board, disconnection between the first wires and the second wires does not occur; and fifth, because the processor can be directly installed on the film by a low temperature process technology, and can be directly coupled to the sensing units of the sensing circuit by the first wires and the second wires, the present invention can make the process of the touch panel simpler.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel, comprising:
a film, wherein sensing units of a sensing circuit, first wires coupled to the sensing circuit, and second wires coupled between the first wires and a processor are formed on the film; and
a cover lens, wherein the film is attached to the cover lens by an adhesive method.

2. The touch panel of claim 1, wherein the sensing units of the sensing circuit, the first wires coupled to the sensing circuit, and the second wires coupled between the first wires and the processor are formed on the film by a printing method.

3. The touch panel of claim 1, wherein the sensing units of the sensing circuit, the first wires coupled to the sensing circuit, and the second wires coupled between the first wires and the processor are formed on the film by an evaporation method.

4. The touch panel of claim 1, wherein the sensing units of the sensing circuit, the first wires coupled to the sensing circuit, and the second wires coupled between the first wires and the processor are formed on the film by a sputtering deposition method.

5. The touch panel of claim 1, wherein the sensing units of the sensing circuit, the first wires coupled to the sensing circuit, and the second wires coupled between the first wires and the processor are formed on the film by a chemical vapor deposition method.

6. The touch panel of claim 1, wherein the sensing units of the sensing circuit, the first wires coupled to the sensing circuit, and the second wires coupled between the first wires and the processor are formed on the film by a photolithography method.

7. The touch panel of claim 1, wherein the sensing units of the sensing circuit, the first wires coupled to the sensing circuit, and the second wires coupled between the first wires and the processor are formed on the film by an etching method.

8. The touch panel of claim 1, wherein the film is a polyethylene terephthalate (PET) film.

9. The touch panel of claim 1, wherein the film is a polyethylene naphthalate (PEN) film.

10. The touch panel of claim 1, wherein first dimensional sensing units and second dimensional sensing units of the sensing circuit are formed on two opposite sides of the film, respectively, wherein the first dimensional sensing units of the sensing circuit are perpendicular to the second dimensional sensing units of the sensing circuit.

11. The touch panel of claim 1, wherein the sensing units of the sensing circuit being formed on the film is first dimensional sensing units of the sensing circuit being formed on one side of the film and second dimensional sensing units of the sensing circuit being formed on one side of the cover lens, wherein the first dimensional sensing units of the sensing circuit are perpendicular to the second dimensional sensing units of the sensing circuit.

12. The touch panel of claim 1, wherein the sensing units of the sensing circuit being formed on the film is first dimensional sensing units of the sensing circuit being formed on one side of the cover lens and second dimensional sensing units of the sensing circuit being formed on one side of the film, wherein the first dimensional sensing units of the sensing circuit are perpendicular to the second dimensional sensing units of the sensing circuit.

13. The touch panel of claim 1, wherein the cover lens comprises:
a hole for covering the processor, wherein the processor is installed on the film.

14. A method of forming a touch panel, the method comprising:
installing a processor on a film;
forming sensing units of a sensing circuit, first wires coupled to the sensing circuit, and second wires coupled between the first wires and the processor on the film; and
attaching the film to a cover lens.

15. The method of claim 14, wherein the sensing units of the sensing circuit, the first wires coupled to the sensing circuit, and the second wires coupled between the first wires and the processor are formed on the film by a printing method.

16. The method of claim 14, wherein the sensing units of the sensing circuit, the first wires coupled to the sensing circuit, and the second wires coupled between the first wires and the processor are formed on the film by an evaporation method.

17. The method of claim 14, wherein the sensing units of the sensing circuit, the first wires coupled to the sensing circuit, and the second wires coupled between the first wires and the processor are formed on the film by a sputtering deposition method.

18. The method of claim 14, wherein the sensing units of the sensing circuit, the first wires coupled to the sensing circuit, and the second wires coupled between the first wires and the processor are formed on the film by a chemical vapor deposition method.

19. The method of claim 14, wherein the sensing units of the sensing circuit, the first wires coupled to the sensing circuit, and the second wires coupled between the first wires and the processor are formed on the film by a photolithography method.

20. The method of claim 14, wherein the sensing units of the sensing circuit, the first wires coupled to the sensing circuit, and the second wires coupled between the first wires and the processor are formed on the film by an etching method.

21. The method of claim 14, wherein first dimensional sensing units and second dimensional sensing units of the sensing circuit are formed on two opposite sides of the film, respectively, wherein the first dimensional sensing units of the sensing circuit are perpendicular to the second dimensional sensing units of the sensing circuit.

22. The method of claim 14, wherein the sensing units of the sensing circuit being formed on the film is first dimensional sensing units of the sensing circuit being formed on one side of the film and second dimensional sensing units of the sensing circuit being formed on one side of the cover lens, wherein the first dimensional sensing units of the sensing circuit are perpendicular to the second dimensional sensing units of the sensing circuit.

23. The method of claim 14, wherein the sensing units of the sensing circuit being formed on the film is first dimensional sensing units of the sensing circuit being formed on one side of the cover lens and second dimensional sensing units of the sensing circuit being formed on one side of the film, wherein the first dimensional sensing units of the sensing circuit are perpendicular to the second dimensional sensing units of the sensing circuit.

24. The method of claim 14, wherein the processor is covered by a hole of the cover lens after attaching the film to the cover lens.
